(19) United States
(12) Patent Application Publication
(10) Pub. No.: US 2013/0211673 A1
(43) Pub. Date: Aug. 15, 2013

(54) Method for Optimizing Heavy Hauler Pneumatic Tire Performance on Multi-Axled and Multi-Tired Vehicles

(71) Applicant: Richard King, Redmond, WA (US)

(72) Inventor: Richard King, Redmond, WA (US)

(21) Appl. No.: 13/768,500

(22) Filed: Feb. 15, 2013

Related U.S. Application Data
(60) Provisional application No. 61/599,039, filed on Feb. 15, 2012.

(51) Int. Cl. B60C 23/00

(52) U.S. Cl. CPC B60C 23/00
USPC 701/36

(57) ABSTRACT

A method for optimizing pneumatic tire performance on a multi-axled and multi-tired vehicle is disclosed. The method requires three events to occur on any single axle with tires in dual configuration: 1) accurate and correct measurement of all tires mounted on the axle; 2) a known super-imposed load weight on the axle; and 3) tire pressures influenced by tire size and imposed load. The simultaneous occurrence of these three events will allow all tires have the same bottom radii that allows them to rotate at the same surface speed. It is necessary to recognize that tires in operation have two radii; a top radius and a bottom radius which is calculated by subtracting the bottom deflection from the top radius. These manipulations achieve uniform bottom radius of all the tires and is the object of the invention. Also, disclosed is an apparatus for measuring the radius of a tire.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

This utility patent application is based on and claims the filing date benefit of U.S. provisional patent application, (Application No. 61/599,039) filed on Feb. 15, 2012.

### BACKGROUND OF THE INVENTION

1. Field of the Invention

This invention relates to tire performance and more specifically to pneumatic tire performance on multi-axled and/or multi-tired vehicles.

2. Description of the Related Art

The heavy hauler trucking industry has struggled with excessive tire pressures, tire performance, tire longevity, tire wear, and tire de-lamination due to excessive heat. Also, it has struggled with irregular tread wear such that tires must be replaced before they are entirely worn, and when in operation can be dangerous to everyone on the highways at any given time. This occurs because excessive tire pressures are universally and uniformly applied to all tires on rigs, in dual configuration, without adequate regard to relative dimensions, position on the vehicle and adjoining dissimilar tire conditions. Optimum deflection and foot print, as previously described elsewhere in U.S. Pat. No. 6,532,812, relate to a single tire configuration on any axle. However, optimum deflections herein may vary slightly in order to achieve uniform bottom radius of all tires on the same axle at the same time; which is paramount to this application.

The industry now relies on measuring tire circumference across the tread width centerline. (see FIG. 2). This method of measuring gives false information. A s the tire contacts the road surface the tread width becomes less convex and wears irregularly in the middle due to over pressuring. Also, this measurement requires that the tire be off of the vehicle, or the vehicle must be jacked up in order to achieve false accuracy. This operation requires excessive labor and time to measure tires, to replace a flat or defective or worn tire with a new tire or another partially used tire. Another problem within the industry is the fact that truckers use the same tire pressures throughout their rig without regard to other options or to varying gross loads. Weighing authorities seem only interested in gross weights of axles or gross weights of combinations of axles. For instance, when weighing an 18 wheeler, three weights are made, first for the steering tires, second for the 8 driver tires (two axles) and third for the 8 trailer tires (two axles). This weighing method does not consider the consequences of not knowing how individual tires on the same axle are operating. As a result this creates unsafe conditions such as so-called thrown “alligators” (tread separations) and thrown whole tires due to excessive heat build-up by over-deflection. This procedure also wastes energy.

### SUMMARY OF THE INVENTION

The present invention offers a means of correctly dimensioning, loading and pressuring different size tires on the same axle, with tires in dual configuration, so that tire optimal performance can be achieved. Optimum tire performance herein is defined as “uniform bottom radius of all four tires on a single axle”. It is based upon correlation of tire dimensions, tire pressures and tire loadings mounted on a single axle simultaneously.

Today, the industry utilizes information published by tire manufacturers, the TRA (The Tire and Rim Association) and various other publications adopted by truckers and trucking companies. In utilizing these publications, scaling authorities have adopted the age-old concept of “allowable maximum load on any tire be not more than 600 pounds per inch of width”. This is inadequate. Even if this method were correct, the inconsistencies of so called uniformity of tire manufacture of tread widths (where the rubber meets the road as described by the Goodyear Tire Company) vary from manufacturer to manufacturer to the extent that reliability is compromised when incorporated into actual use. The section width is used, presumably, by industry because it is a published consistent dimension for each tire size due to dual tire clearance requirements when in operation; and nowhere can universal uniformity be found where, in fact, the rubber does meet the road. Actual tread widths and diameters can only be found by actual measurement of each tire. Periodic adjustments must be made to individual axles because tires get smaller in diameter due to wear, and then will require greater pressures to carry the same load.

Disclosed herein is a solution to the problem of excessive tire wear of same size tires mounted on a multi-tired axle by adjusting the pressure in each tire so that all of the tires have same bottom radius or that rotated on the axle at the same rate.

It is an object of the present invention to accurately dimension individual tires.

It is also an object of the present invention to assure that no one tire size shall exceed the other tires on an axle by more or less than one half inch in diameter in order to prevent excessive deflection.

Further, it is an object of the present invention to proportionately pressurize tires in relationship to other tires on the same axle.

Also, it is an object of the present invention to more closely distribute equal loadings on all four tires on one axle.

It too is an object of the present invention that each axle operate independently of other axles although with the same characteristics as other axles as described by this invention.

And it is also an object of the present invention to manipulate all four tires on a single axle in order to keep the overall cargo balanced athwart and to allow greater, freer and more common use of the “interlock” without stressing major drive components such as gears, bearings, pinions, races, spindles and axles.

It is also an object of the present invention to achieve identical bottom radii of all tires on the same axle so that they rotate at the same surface speed.

These and other relevant objects and methods will become apparent to those skilled in the art of performing and understanding these tasks and upon reading following detailed descriptions and also by analyzing and understanding the graphics herein:

### DESCRIPTION OF THE DRAWINGS

FIG. 1 is an illustration of tires in operation each with a top radius that is in constant relationship to the tire circumference at all times and a bottom radius which always differs from the top radius and is generated by applying different loads, different pressures in the tire and also accurately measuring different tire sizes; all of which result in achieving the appropriate deflections.

FIG. 2 is a partial, front sectional view of a tire depicting the tire's real world diameter, tread deflection distance, and overall diameter.

FIG. 3 is an illustration showing an exploded, U-shaped tire caliper used to measure the radius of a tire with the caliper comprising two right angled elements linked together and showing the length measurement indicia printed on the back surface of the inside right angled element.

FIG. 4 is a top plan view of an 18 wheeler showing the basic axles and tire configurations.

### DESCRIPTION OF THE PREFERRED EMBODIMENT(S)

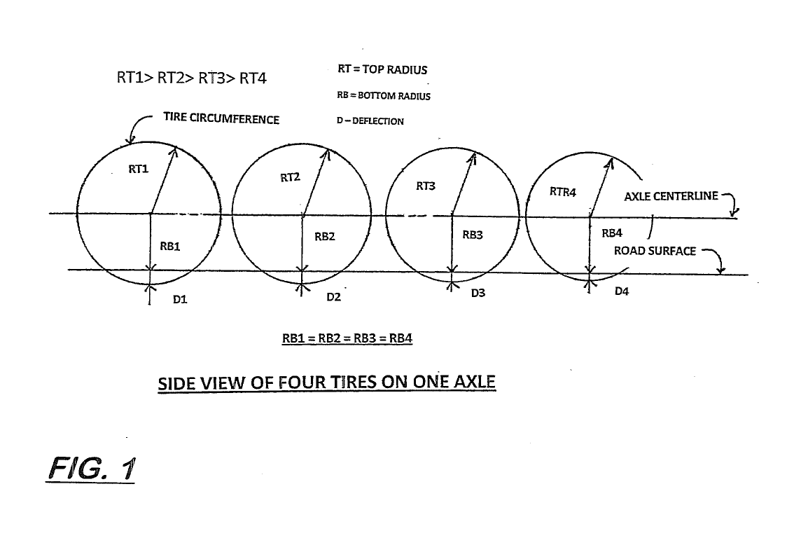

The invention is best understood by considering a graphic example on one mult-tired axle. FIG. 1 assumes the tires are all of different circumference (within parameters) due to various stages of use and wear and that the tires are recommended by TRA publications and therefore have the same section widths. The largest of the multiple tires on a single axle cannot exceed the smallest tire in diameter by one half inch so that the largest tire will not deflect excessively and cause heat build-up.

FIG. 1 is graphic that is exaggerated only to make the point more clearly and to show, a seldom discussed (relevant to this application) but very important fact, that tires in operation have two radii; a top radius that is in constant relationship to the tire circumference at all times and a bottom radius which always differs from the top radius and is generated by applying different loads, different pressures in the tire and also accurately measuring different tire sizes; all of which result in achieving the appropriate deflections.

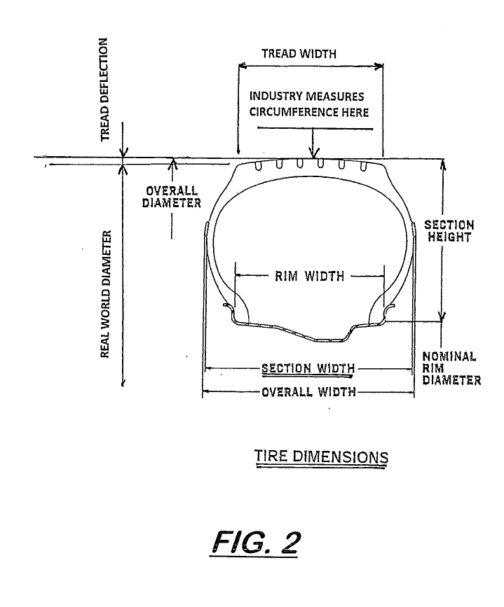

FIG. 2 is a partial, front sectional view of a tire depicting the tire's real world diameter, tread deflection distance, and overall diameter.

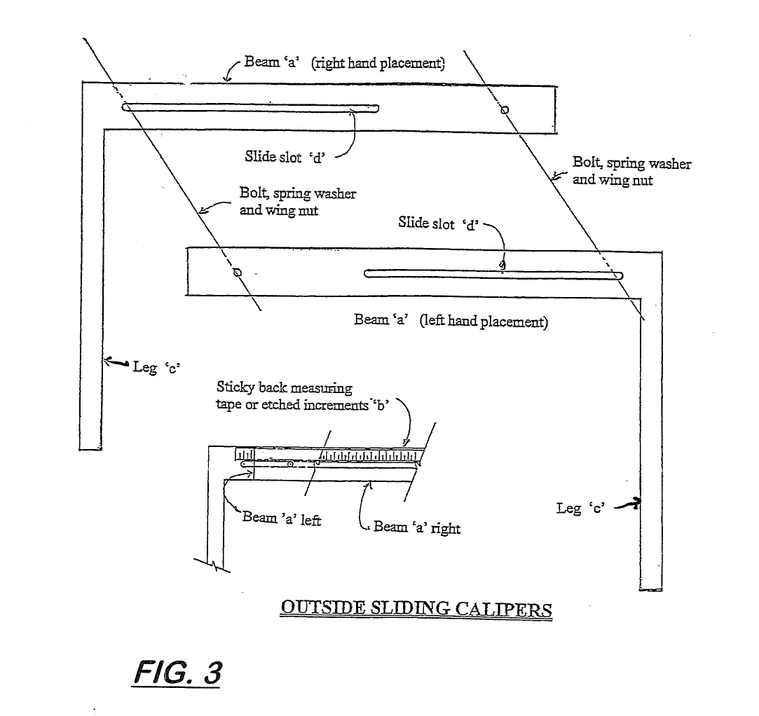

FIG. 3 shows an appropriate tire measuring apparatus that includes a first and second L-shaped element each with a straight beam and a perpendicularly aligned leg, said first and second beams being aligned and stacked together and connected together so that they may slide longitudinally over each other thereby enabling said legs may be positioned apart and different distances. Formed or printed on surface of at least one beam is a length measuring scale or measurer that indicates the distance the inside edges of the two legs are spaced apart.

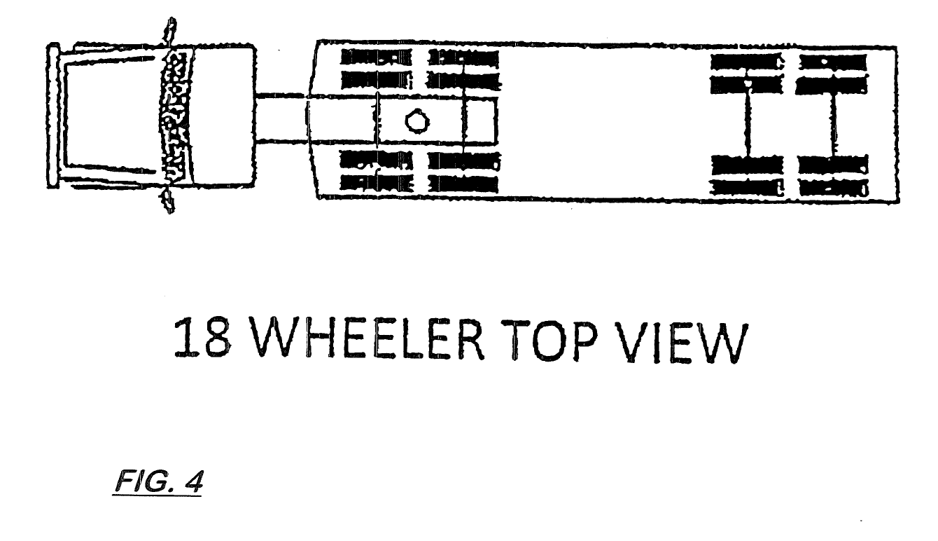

FIG. 4 is a plan view of an 18 wheeler showing the basic axles and tire configurations.

It is therefore discernible that each tire can be deflected (flattened out on the bottom) the correct amount to achieve the same bottom radius when accurate dimensions are made and different loads are applied and by adjusting the amount of pressure in each of the tires. It is important again to mention that there are other controlling parameters which restrict the differences in multiple tires on a single axle. A tire that is one tenth of an inch greater or smaller in diameter than its adjoining tire will tend to go farther or shorter by about thirteen feet per mile; a significant difference when traveling thousands of miles per year. This application will preclude that.

Having thus described in detail the method for optimizing tire performance by achieving the same bottom radii of each tire on the same axle, it will be obvious to those skilled in the art that many other useful variations may constructively be achieved.

The method includes the following steps:
a. calculating the amount of gross weight exerted on each axle;
b. determining the number of tires on each axle;
c. adjusting the air pressure on each tire so that each tire mounted on said axle has the same bottom radius;, and,
d. repeating steps (a-c) for each axle on said motor vehicle.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1) A method of mathematically achieving uniform tire bottom radii for the purpose of allowing multiple tires in dual configuration on a single axle to rotate with the same surface speed.
a. A method of claim #1 in achieving different tire deflections by various means.
b. A method of claim #1 in achieving different tire bottom radius by various means.
c. A method of claim #1 in achieving different tire pressures by various means.
d. A method of applying claims a, b, and c, proportionately and simultaneously to all tires in dual configuration on a single axle.
e. A method of claim ‘d’ in which each individual axle operates independently of other axles; but with the same characteristics as other multiple tired axles implemented in the same manner on the same rig.

2. A method of optimizing tire performance on a multi-axle and multi-tired motor vehicle, comprising the following steps:
a. calculating the amount of gross weight exerted on each axle;
b. determining the number of tires on each axle;
c. measuring the diameter of each tire;
d. adjusting the air pressure on each tire so that each tire mounted on said axle has the same bottom radius; and,
e. repeating steps (a-c) for each axle on said motor vehicle.

3. The method as recited in claim 2 wherein the step c of measuring the diameter of each tire is carried out using a measuring apparatus comprising;
a. a first and second L-shaped element each with straight beam and a per perpendicularly aligned leg, said beams being coaxially aligned and stacked together and configured to slide longitudinally over each other so that said legs may be positioned apart and different distances; and,
b. length measuring indicia formed or printed on at least one beam that indicates the distance the two legs are spaced apart.

4. A method of optimizing performance on tires to reduce excessive wear on tires mounted on same axle by adjusting the pressure in each tire so that all of the tires mounted on the axle have the same bottom radius.
